(19) United States
(12) Patent Application Publication
(10) Pub. No.: US 2012/0311822 A1
(43) Pub. Date: Dec. 13, 2012

(54) Solute crystallizing apparatus

(76) Inventor: Joseph Bradley Culkin, Emeryville, CA (US)

(21) Appl. No.: 13/134,572

(22) Filed: Jun. 10, 2011

(51) Int. Cl. B01D 9/00

(52) U.S. Cl. 23/295 R; 422/245.1

(57) ABSTRACT

A solute crystallizing apparatus utilizing a solution having solute and a first solvent. A mixing unit for combining the solution and a second solvent which lowers the solubility of the solute. A pump receives the mixed solute, first solvent and second solvent and outputs the same under a positive pressure. A membrane separator, having a membrane, receives the pressured solute, first solvent and second solvent mixture and produces a slurry of crystals of the solute, the first solvent, and second solvent as the concentrate or retentate. A solution of the solute, the first solvent and second solvent passes through the membrane as permeate. The concentration of the solute in the retentate is greater than the concentration of solute in the permeate.

### BACKGROUND OF THE INVENTION

The present invention relates to a novel and useful solute crystallizing apparatus.

Crystallization is an important industrial process since many materials may be employed and profitably sold in crystalline form. Crystallization enjoys wide use due to the crystalline material, or, chemical solid, which is highly purified and may be gotten from relatively impure solutions through a single processing step. In addition, the energy required to perform crystallization is much less then that employed for distillation or other methods of purification. Moreover, crystallization may take place on a mass scale of large variation, from a few ounces to several tons.

Prior art crystallizers, such as the evaporator type crystallizers, direct contact, refrigeration crystallizers, reaction type crystallizers and the like, require a large expenditure of energy in the form of heat, steam, or electricity. Also, crystals falling from solution have a tendency to be tenacious and abrasive to scraper blades, requiring special materials of construction, which are, again, very expensive. In addition, the equipment of prior art crystallizers are usually custom designed to recover a particular solute. This entails high capital and operating costs.

In addition, it is desirable and necessary under certain regulations to crystallize solutes using a system having zero liquid discharge characteristics. Therefore, it is necessary to provide a crystallizer which is cost effective and efficient during operation.

In the past, solutions have been treated with an additional solvents to induce precipitation of crystals. Such precipitation is followed by a liquid-solid separation, such as one accomplished by a cyclone separator, followed by solvent recovery through distillation tower.

A crystallizer which is versatile and economical would be a notable advance in the field of solute recovery.

### SUMMARY OF THE INVENTION

In accordance with the present invention a novel and useful crystallizing apparatus for solutes is herein provided.

The crystallizer apparatus of the present invention employs a mixing unit for a solution which includes a first solvent and the solute, and a second solvent. Second solvent is continuously added to separate the solute as a solid via reduction or the solubility of the solute and the osmotic pressure of the mixture heretofore described, resulting in a slurry.

The slurry of the solute and the first and second solvent is then passed to a pump which outputs such components under a positive pressure. Such pressure typically runs between 100 psi and 900 psi.

Following pressurization of the slurry, the pump outputs the same to a membrane separator having a membrane, which may be a reverse osmosis membrane. A slurry of crystals of the solute in the first and second solvents pass through the membrane separator as retentate or concentrate. The solution of the solute and the first and second solvents are forced through the membrane of the membrane separator as permeate, such that the concentration of the solute is greater in the retentate than in the permeate. The membrane separator may also take the form of an oscillational torsional motion device. Such device imparts torsional motion to the membrane and greatly increases the efficiency of separation within the membrane separator.

Following movement of the slurry components through the membrane separator, the retentate is directed to a dryer to recover the crystals. The dryer may take any conventional form such as a spray dryer, a tray dryer, a freeze dryer, a fluid energy mill, a cyclone separator, a solid bowl centrifuge, a heated press, and the like.

The permeate exiting the membrane separator passes to a solvent recovery device. The solvent recovered is then led back into the feed of the system for recirculation. Solvent recovery may take the form of a distillation column or a second membrane separator. In any case, the remaining solute in the first solvent may also be passed back into the system where such components are able to be employed without disrupting the solute crystallization.

The present invention also includes a process for crystallizing a solute in a solution which follows the steps of adding a second solvent to the solution to form a slurry and passing the same to a pump to pressurize the slurry. The slurry is then directed to a membrane separator which produces a slurry of crystals of the solute in the first and second solvents as retentate, and a solution of the solute and the first and second solvents as permeate. The concentration of the solute is greater in the retentate than in the permeate. An additional step of drying retentate to recover the solute may follow. In addition, solvent found in the permeate may be passed to a solvent recovery apparatus for recirculation of the same in the system.

It may be apparent that a novel and useful solute crystallizing apparatus has been hereinabove described.

It is therefore an object of the present invention to provide a solute crystallizing apparatus which uses a membrane separator to continuously produce a concentrate of a slurry of crystals of the solute.

Another object of the present invention is to provide a solute crystallizing apparatus which employs a membrane separator in combination with an oscillational torsional motion device to impart torsional motion to the membrane within the membrane separator.

A further object of the present invention is to provide a solute crystallizing apparatus which is capable of being used in combination with a solvent recovery system to minimize waste.

Another object of the present invention is to provide a solute crystallizing apparatus which is highly efficient and economical.

A further object of the present invention is to provide a solute crystallizing apparatus which may be employed with any number of solutes without specialized design of components of the system.

Another object of the present invention is to provide a solute crystallizing apparatus which may operate at near ambient temperatures in a very efficient manner.

A further object of the present invention is to provide a solute crystallizing apparatus which eliminates moving parts found in the prior art crystallization apparatuses.

Yet another object of the present invention is to provide a solute crystallizing apparatus which may be employed in the system which operates at near zero liquid discharge conditions.

The invention possesses other objects and advantages especially as concerns particular characteristics and features thereof which will become apparent as the specification continues.

### BRIEF DESCRIPTION OF THE SEVERAL VIEWS OF THE DRAWING

FIG. 1 is a sectional schematic view of a prior art crystallizing system.

FIG. 2 is a schematic depicting a prior art slurry crystallization process using a cyclone separator.

FIG. 3 is a schematic view showing the solute recovery and crystallization system of the present invention.

FIG. 4 is a respective schematic view of and oscillational torsional motion device used in conjunction with the membrane separator of the present invention.

FIG. 5 is a schematic view depicting recirculation of a solvent component to a brine concentrator block used as a feed to the membrane concentrator.

For a better understanding of the invention reference is made to the following detailed description of the preferred embodiments of the invention which should be taken in conjunction with the above described drawings.

### DETAILED DESCRIPTION OF THE PREFERRED EMBODIMENTS OF THE INVENTION

Various aspects of the present invention will evolve from the following detailed description of the preferred embodiments thereof which should be referenced to the prior described drawings.

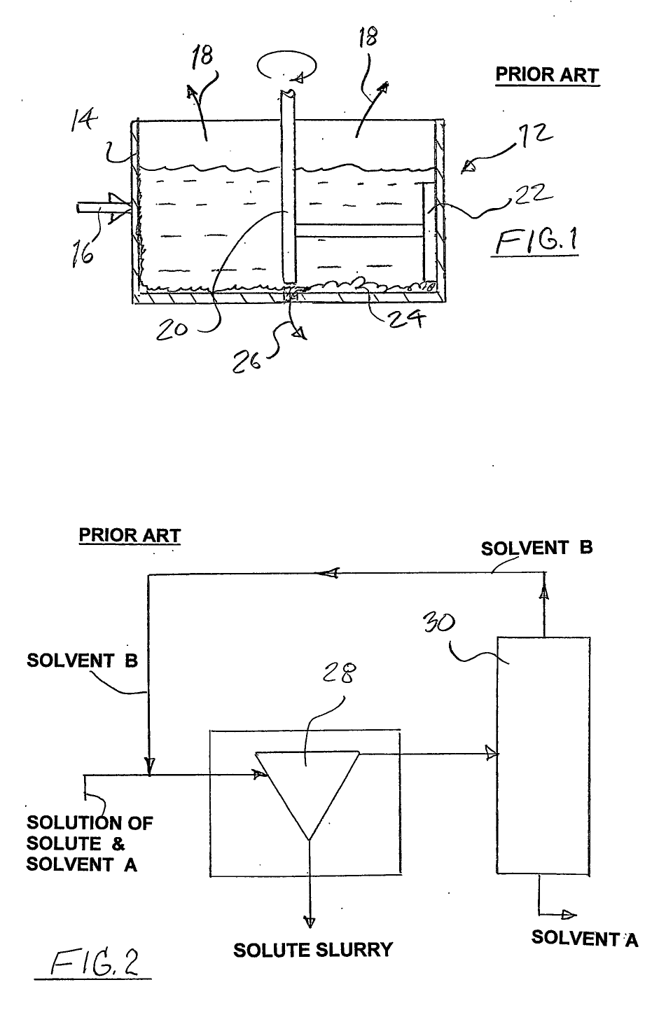

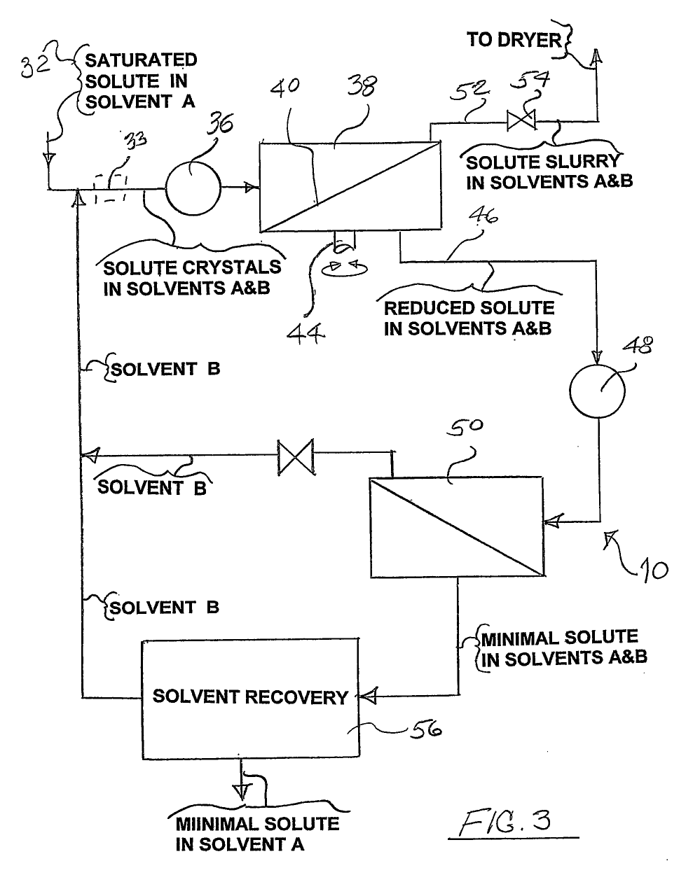

A preferred embodiment of the invention is depicted in the drawings by reference character 10, FIG. 3, and is a distinct improvement over the prior art depicted in FIGS. 1 and 2. For example, FIG. 1, depicts a scraper crystallizer 12 having a vessel 14 containing a solution. Heat is applied in the form of steam or electrical energy creating thermal evaporation, arrows 18, which may also be in the form of steam. Mechanical work is applied to a central shaft 20 which operates a scrapper 22 that directs the crystals 24 to the bottom of vessel 14 and through an exit, directional arrow 26. Needless to say, scraper 22 must be formed of extremely strong material, such as titanium, and the system depicted in FIG. 1, also requires the notable addition of energy. Also, the system shown in FIG. 1 requires a high capital cost and a high operating cost to produce crystals 24.

The prior art system depicted in FIG. 2 utilizes the feeding of an solution of a solute and a first solvent A and the addition of a second solvent B, prior to transportation of the same of a cyclone separator 28. A solute slurry formed passes from the bottom of the cyclone separator 28 while solvents travel to a solvent recovery apparatus 30 in the form of a distillation tower. Solvent B is then recycled while solvent A is then discarded.

Turning now to FIG. 3, it may be observed that the apparatus 10 of the present invention is depicted schematically. In system 10, solute is dissolved in a first solvent A to form a feed solution 32. A second solvent B is then added to the feed 32 in order to lower the solubility of the solute in feed 32 and form a slurry. In other words, solute crystals are formed in solvents A and B following the addition of solvent B. Such event also reduces the osmotic pressure of the solute crystals, found in solvents A and B. The combining of the solute, solvent A and solvent B may take place in a mixing unit which may take the form of a vessel or a simple conduit. A pump 36 then pressurizes the slurry of solute crystals in solvents A and B. Such pressurization usually ranges between 100 and 900 psi. The slurry of solute crystals in solvent A and B is then sent to membrane separator 38 which may include a reverse osmosis membrane 40. Such membrane 40 may take the form of a suitable reverse osmosis membrane such as an energy saving polyamide (ESPA), BW, and F, NE, and like membranes constructed of thin film composite (TFC) polyamides. The porosity of such filters generally varies between 40 daltons and 180 daltons.

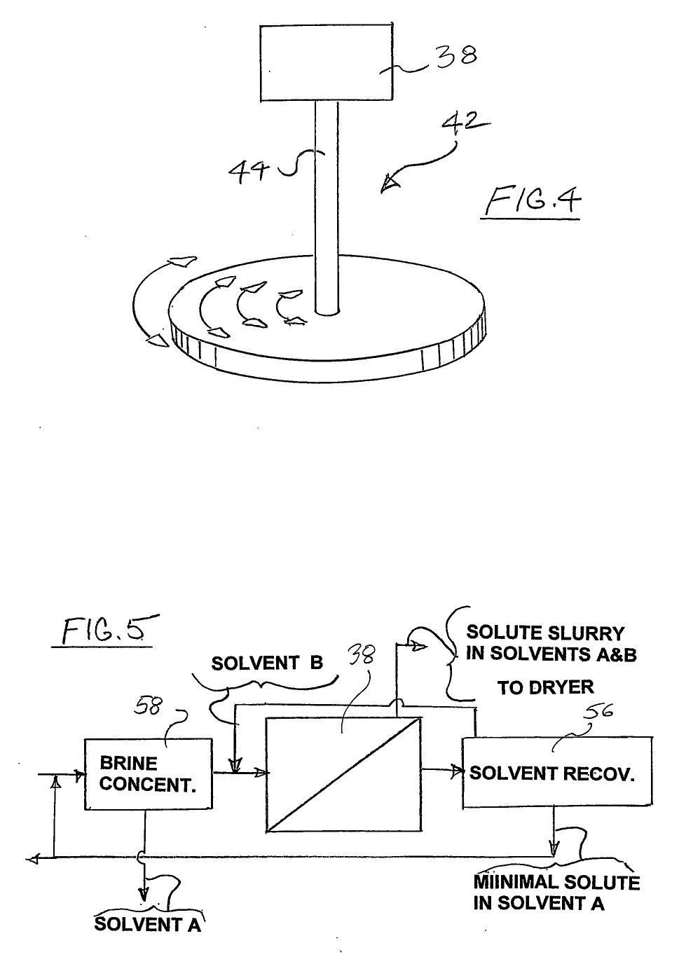

Also, membrane separator 38 may take the form of a commercially available membrane filtration system known as VSEP, manufactured by New Logic Research Inc., of Emeryville, Calif. Such VSEP device also includes an oscillational torsional motion portion 42 indicated partially by shaft 44, FIG. 3, such device 42 is depicted in FIG. 4 and is detailed in U.S. Pat. Nos. 4,952,317, and 5,014,564, which are incorporated by references, in whole, to the present application. It has been found that such device 42 is highly efficient in separating crystals slurry concentrates from solvent permeates.

The system 10 as is shown in FIG. 3 may be employed in a system where the dissolved solids or solutes are capable of dissolving in solvent A but not as likely to dissolve in solvent B, as long as solvents A and solvent B (the mother liquor) are highly miscible. Water and ethanol suit this criteria. In addition, methanol, ammonia, and pressurized carbon dioxide may also be employed as solvent B with suitable solvent A. In addition, the solvent B should not react with any of the solute in the solution of solvent A and solvent B. In other words, ammonia would not be desirable with sodium chloride as a solute.

As a typical feed 32 to system 10, water and ethanol may be employed as solvents A and B, respectively. The addition of solvent B to solvent A and solute would produce a 70/30 ethanol to water mixture. Pump 36 would then operate at about 600 to 700 psi, resulting in a throughput exiting membrane separator 38 of about 10-15 gallons per square foot per day. Although ethanol exceeds water in the feed to pump 36, a very high concentration of solvent B is not desirable since recovery of solvent B would be reduced, as it will be explained as the specification continues. The pH of feed 32 may be chosen to obtain minimum solubility of solute in solvent A. In addition, low temperatures, typically between 25 degrees centigrade to 80 centigrade, may be employed in the present system. For example, the following ethanol/water systems exhibit working pressures that are typical for system 10 of the present invention:

| Ethanol/water | Pressure |
|---|---|
| 50/50 | 1300 psi |
| 60/40 | 1100 psi |
| 70/30 | 900 psi |

It has also been found, that the optimum molecular weight of membrane 40 cut off is very close to the solvent molecular weight. For example, 40 daltons for ethanol and 30 daltons for methanol would serve as the cut off for the molecular weight characteristic of membrane 40.

In general near saturation, the ionic association of salts becomes incomplete, and significant amounts of salt, such as sodium chloride, would exist in solution, but in a non-ionic and undissociated form. When this occurs, poor rejection by membrane 40 takes place. This is due to the size of the undissolved salt being smaller than the size of the ions when the water of hydration is included in estimating the size of the ions. For example, even though the nominal rejection by ESPA type RO (reverse osmosis) membrane is over 98 percent for weak sodium chloride solutions, the rejections of 6 percent sodium chloride in 70/30 ethanol/water saturation, is only about 66 percent. Thus, the permeate 46 from membrane 40 is about 2 percent sodium chloride. Since permeate 46 is not saturated a second pump 48 and membrane separator 50 may be employed with or without a solvent recovery block 56 (typically a distillation tower). Membrane separator 50, a second pass membrane system, has a much higher rejection. For maximum salt rejection, a spiral wound type membrane separator may be used in separator 50. This is the case, since solids are not likely to be precipitating during movement through second membrane separator 50.

In any case, the slurry of solute and solvent A and B is passed as concentrate or retentate 52 through membrane separator 38 in a typical system, using sodium chloride as a solute and solvents A and B of water and ethanol, respectively. A slurry of 30 to 70 percent of sodium chloride crystals in 70/30 ethanol water is produced as retentate or concentrate 52. Retentate 52 may be regulated by valve 54 and passed to a dryer of suitable conventional configuration. For example, the retentate 52 may be feed to a heated filter press of the hot bladder type, a heated scroll discharge centrifuge, or a screw press. In addition, other options exist for the drying of the solute crystals in retentate 52 such as spray drying, tray drying, freeze drying, fluid energy mills, cyclones, solid bowl centrifuges, sedimentation tanks, belt presses, and the like. When methanol is used as solvent B, activated carbon may be employed to remove trace amount of methanol from the water leaving solvent recovery block 56. Needless to say, the solutes and solvents as permeate 46 may be passed to solvent recovery block with or without the use of secondary membrane separator 50. In any case, solvent B is then recycled to feed 32 either from solvent recovery block 56, membrane separator 50, or both. The minimal solute in solvent A (water and salt for example) from solvent recovery block 56 may be also passed to feed stream 32.

Turning to FIG. 5, it may be observed that a brine concentrator 58 may be employed as the source or the stream entering separator 38. Thus, the minimal solute in solvent A recovered from solvent recovery block 56 may be passed to brine concentrator 58 in this system. In addition, such recirculation of the minimum solute in solvent A from recovery block 56 may be fed into system 10 where similar concentration of total dissolved solids exist.

Commercial application for system 10 may include the already mentioned sodium chloride brine concentrator and water recovery process, typically used in the oil industry. In addition, the following general ionic solids may be recovered in system 10 of the present invention, for example:

sodium alluminate solutions,
sodium sulfate solutions,
sodium nitrate solutions,
calcium chloride solutions, and the like. Generally any solutes which have been, heretofore, unworkable due to extreme high osmotic pressure may be recovered via system 10 of the present application. In addition, non-ionic crystallization may be achieved in system 10. For example, crystallization and recovery of sucrose may occur.

The following examples are presented to illustrate the present invention but are not intended to restrict the invention at any manner.

### Example I

Various salt solutions and ethanol mixtures were tested in order to identify a target blend ratio which would reduce the osmotic pressure of the same to a target level of approximately 300 psi. After several tests, a blend of 70 percent ethanol as a second solvent, and 30 percent saturated salt solution, using water as a first solvent, was selected.

### Example II

A filter pack using ESPA RO as a membrane was installed into a VESEP p-mode system. Water flux and salt rejection of the membrane were verified prior to beginning separation. The ESPA pack exhibited a porosity of 40 daltons. After confirming that the membrane was installed in good condition, a feed solution was prepared in a feed tank as followed:

1. 2.5 gallons of salt water mixture was prepared containing 23.92 percent sodium chloride.

2. 7.5 gallons of ethanol was added to the water mixture. Upon addition of the ethanol to the water mixture, sodium chloride crystals precipitated, out of the solution. Following a time delay to allow complete precipitation, the system was run in a recirculation mode in order to measure the flow rate of the water/ethanol mixture through the RO membrane. At 500 psi as the feed pressure, a flow rate of 136/ml/min was observed.

The ethanol concentration of the original feed mixture was increased by adding 2.5 gallons of pure ethanol to the feed tank. This increased the overall concentration of ethanol to roughly about 80 percent. The impact of the such additional ethanol concentration on flow rate was measured. At a pressure of 500/psi, a flow rate of 162.5 ml/min resulted.

### Example III

Using the initial feed solution of Example II, various membranes were chosen to test the operation of an LP VSEP unit in L-mode operation. The following membranes were used:

| Membrane Type | Porosity | Material |
|---|---|---|
| ESPA (Energy) | 40 da | TFC Polyamide |
| Saving Polyamide) | | |
| BW-30 | 50 da | TFC Polyamide |
| NF-90 | 90 da | TFC Polyamide |
| NE-70 | 180 da | TFC Polyamide |

The objective of testing the various membranes was to find a membrane tight enough to have good sodium chloride rejection properties and which also allowed ethanol to pass through the membrane freely. The results of the membrane selection was that ESPA membrane worked best, since the other membranes did not significantly increase flow rate of pure ethanol.

### Example IV

Using an ESPA membrane in a VSEP L-mode membrane separator, a high pressure concentration study was completed using 70 percent ethanol and 30 percent saturated salt blended as a feed material. The test was completed in order to show the ability of the ESPA membrane to concentrate the material at 900 psi with reasonable flow rates. A satisfactory flux of around 10 GFD was achieved with such feed at 900/psi.

While in the foregoing, embodiments of the present invention have been set forth in considerable detail for the purposes of making a complete disclosure of the invention, it may be apparent to those of skill in the art that numerous changes may be made in such detail without departing from the spirit and principles of the invention.

What is claimed is:

1. A solute crystallizing apparatus utilizing a solution having a solute and a first solvent;
comprising:
a. a mixing unit for the solution including the solvent dissolved in the first solvent and a second solvent, said second solvent lowering the solubility of said solute;
b. a pump, said pump receiving said mixed solute, first solvent and second solvent, and outputting said mixed solute, first solvent and second solvent under a positive pressure;
c. a membrane separator said membrane separator including a membrane and receiving said mixed solute first solvent and second solvent under positive pressure and producing a slurry of crystals of the solute, the first solvent and said second solvent, as retentate, and a solution of the solute; the first solvent and said second solvent as permeate, the concentration of the solute in said retentate being greater than the solute in said permeate.

2. The apparatus of claim 1 which additionally comprises a dryer for said solute in said retentate.

3. The apparatus of claim 2 in which said dryer is selected from the group comprising a spray dryer, a tray dryer, a freeze dryer, a fluid energy mill, a cyclone separator, a solid bowl centrifuge, and a heated press.

4. The apparatus of claim 1 in which said membrane comprises a reverse osmosis membrane.

5. The apparatus of claim 1 which additionally comprises a solvent recovery device, said solvent recovery device receiving as input said permeate from said membrane separator.

6. The apparatus of claim 1 which additionally comprises an oscillational torsion motion device for imparting torsional motion to said membrane.

7. The apparatus of claim 6 which additionally comprises a dryer for said solute in said retentate.

8. The apparatus of claim 7 in which said dryer is selected from the group comprising a spray dryer, a tray dryer, a freeze dryer, a fluid energy mill, a cyclone separator, a solid bowl centrifuge, and a heated press.

9. The apparatus of claim 6 in which said membrane comprises a reverse osmosis membrane.

10. The apparatus of claim 6 which additionally comprises a solvent recovery device, said solvent recovery device receiving as input said permeate from said membrane separator.

11. A process for crystallizing a solute in a solution having a first solvent comprising the steps of;
a. adding a second solvent to the solution of the solute and the first solvent;
b. producing a slurry of crystals of the solute, the first solvent, and said added second solvent;
c. pressurizing the slurry of crystals of the solute and the first solvent and said added second solvent;
d. passing the slurry of the solute and the first solvent with said added second solvent to a membrane separator, and;
e. producing a slurry of crystals of the solute the first solvent and the second solvent as retentate from said membrane separator and a solution of the solute, the first solvent, and said second solvent as permeate, the concentration of the solute being greater in said retentate than in said permeate;

12. The process of claim 11 which additionally comprises the step of drying said retentate to recover said solute.

13. The process of claim 11 in which said membrane comprises a reverse osmosis membrane.

14. The process of claim 11 which additionally comprises the step of applying an oscillational torsion motion to said membrane.

15. The process of claim 14 which additionally comprises the step of drying said retentate to recover said solute.

16. The process of claim 14 in which said membrane comprises a reverse osmosis membrane.
